(19) United States
(12) Patent Application Publication
(10) Pub. No.: US 2012/0215361 A1
(43) Pub. Date: Aug. 23, 2012

(54) process for the processing of food products, in particular for the processing of ice-cream, and machine for effecting said process

(75) Inventor: Genesio Bravo, Alte Ceccato-Vicenza (IT)

(73) Assignee: G.S.G. S.R.L., Vicenza (IT)

(21) Appl. No.: 13/497,159

(22) PCT Filed: Sep. 29, 2010
(86) PCT No.: PCT/EP2010/005963

§ 371 Date: Mar. 20, 2012

(30) Foreign Application Priority Data
Nov. 10, 2009 (IT) MI2009A001961

(51) Int. Cl. G05B 15/00

(52) U.S. Cl. 700/275

(57) ABSTRACT

A machine for processing food products in at least one basin (12a, 12b) with the use of a mixer (13a, 13b) activated by a motor (11a, 11b) controlled by an inverter (10a, 10b), in turn in communication with an electronic card with a micro-processor (1), equipped with an electronic bidirectional communication circuit (9) with serial transmission and protocol of the Modbus, Canbus or Profibus type, suitable for revealing the instantaneous state of said inverter (10a, 10b). The process and machine of the invention offer the advantage of controlling the effective execution of each processing phase of the product, repeating it automatically if this is not so.

The present invention relates to an improved process for the processing of food products, in particular for the processing of ice-cream. The invention is also extended to the machine used for effecting this process.

The process and machine to which the invention refers can be used in the processing of food mixtures (such as ice-cream, pastry cream, chocolate, delicatessen products and so forth), subjected to single or combined thermal treatment (for example cooling alone, or heating and cooling) inside a cylindrical basin equipped with a stirrer or rotating mixer. The rotation of the latter is also controlled by means of an appropriate electronic circuit, programmed for the recipe to be prepared.

In machines known for the processing of food mixtures, the velocity of the motor which activates the mixer is promoted starting from an electronic card, programmed for this purpose, whose digital signal is read by an inverter, after conversion to a corresponding analog signal operated by a digital to analog converter, DAC.

The analog signal which is transmitted to the inverter, destined for controlling the rotation rate of the motor and therefore the mixer, is, however, a low-frequency signal which is the cause of the drawbacks examined hereunder.

First of all, the communication from the microprocessor card to the inverter, through the DAC, is subject to various disturbances of an electromagnetic nature, caused by the inverter itself. There is no point in explaining at length how these disturbances can be generated within the circuit logics of the inverter, but they can certainly arise in the communication (connection) wire between the DAC and inverter (causing positive or negative voltage spikes, which can be added to or subtracted from the supply voltage of the same inverter) and less frequently, but this cannot be excluded, also in the wire of digital signals which pass to the DAC from the microprocessor card. These false impulses can cause anomalies in the orders received by the inverter, either blocking it or making it operate with the disturbance signal, instead of the correct signal coming from the card.

In the known machines of the type under examination, there is also the disadvantage that the actuation motor of the mixer, through the intermediation of the inverter, can only operate for quantized voltage variations, i.e. sufficiently intense as to dominate the background noise caused by the inverter, with evident limitations on the selection scale of the rotation rates of the mixer. Operating with a voltage varying from 0 to 10V, for example, a different velocity can be associated for each 1V of voltage increase, consequently up to a maximum of 10 rates, totally insufficient for guaranteeing the correct formation of the product, compared with the wide variety of processings requested of these machines.

There is also the additional disadvantage that the change in the velocity regime of the motor takes place almost instantaneously, according to the only layout possible for the known system, i.e. that controlling the stoppage of the motor in the case of accidental opening of the lid of the mixer in movement. This prevents the acceleration/deceleration variation dynamism which however is required for the passage from one rotation velocity regime to another.

Another problem linked to known machines for the processing of food products, derives from the substantial mono-directionality of the analog communication signal between the DAC and inverter. This communication is in fact exclusively effected from the microprocessor card towards the inverter, passing through the DAC, without any possibility of effecting a reverse run. For this reason, the inverter can in no way communicate with the electronic card, and this in turn is not capable of knowing the response of the inverter to the signal previously transmitted to it (i.e. the system is not able to verify the effective and accurate actuation of the program, which prevents certain processing choices to be automatically effected).

The main objective of the present invention is to provide a process and the relative machine for effecting this, suitable for allowing an extreme diversification in the rotation rates of the motor, so as to guarantee for each recipe inserted in the memory of the microprocessor card, a sequence of operations, each marked by a specific rotation rate for said preparation.

A further objective of the invention is to provide a machine of the type indicated above, in which the inverter is driven on the basis of a software program inside the microprocessor, suitable for communicating the exact rotation rate of the motor at the appropriate moment and with entity changes which can also be infinitesimal.

Another objective of the invention is to provide a process and machine in which the change in the mixing velocity regime of the ingredients is not instantaneous but gradual, with acceleration/deceleration regimes selected in relation to the specific recipe to be prepared.

The invention also has the objective of providing a machine of the type specified above, equipped with a communication system to the inverter which is immune to errors generated by random disturbances caused by electric lines.

Another objective of the machine and process of the invention is also to continuously monitor the precise operating condition of the inverter, intervening on it with specific commands if the optimum operating conditions are not respected.

Finally, an objective of the invention is to provide a machine which allows the insertion of a series of inverter devices, suitable for driving various motors using a single communication wire.

These and other objectives are achieved with the process and machine of claims 1, 12 and 14, 17 respectively. Preferred embodiments of the invention are indicated in the remaining claims.

With respect to the known art in this field, in the machine of the invention, the signal sent from the microprocessor card acts on the inverter in advance with respect to the disturbance, in this way overcoming the drawbacks due to the latter. The inverter is in turn capable of distinguishing the disturbance signals from the command signals coming from the card.

Thanks to the invention, the process is also no longer actuated for quantized variations in the rotation rate of the motor, but for frequency infinitesimals of the current with which the inverter activates the motor. The same invention also allows the acceleration/deceleration time of the motor to be selected, thus graduating the passage from one velocity regime to another in relation to the recipe to be prepared.

Finally, the process and machine of the invention offer the advantage of controlling that each processing phase of the product has actually been effected, repeating them automatically if this is not the case.

A further advantage of the machine of the invention lies in the possibility of limiting the number of wires between the electronic card and inverter, also in the case of the contemporaneous presence of various basins for the processing of the ingredients.

These and other objectives, advantages and characteristics are evident from the following description of a preferred embodiment of the invention, illustrated, as a non-limiting example, in the figure of the enclosed drawings, wherein:

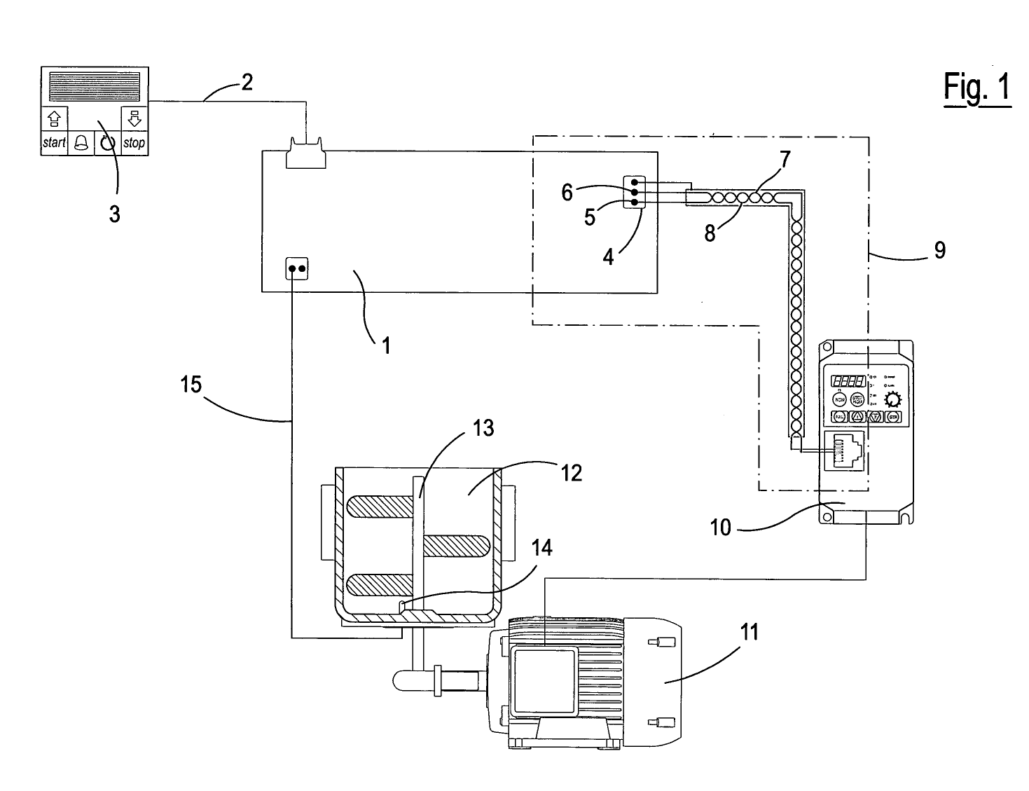

FIG. 1 illustrates a block scheme of the main constitutive elements of the machine of the invention, integrated with the respective connections; and

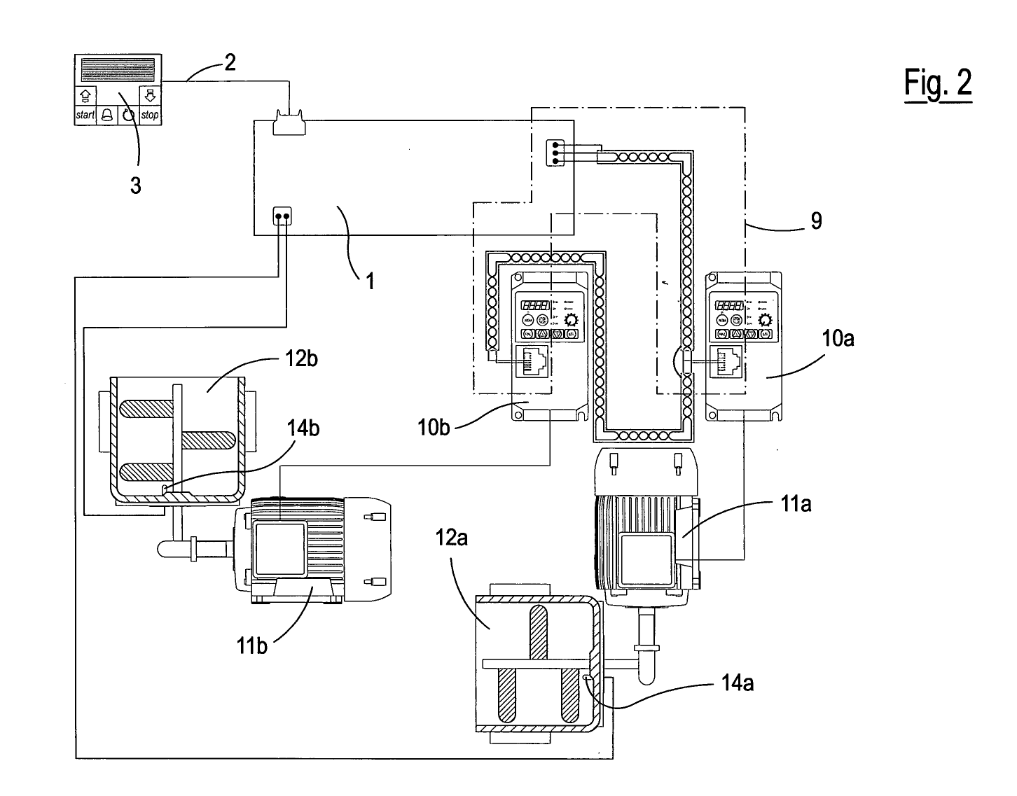

FIG. 2 illustrates the machine of FIG. 1, in the variant equipped with a series of basins for processing the ingredients.

In the example illustrated, the machine is of the type normally used for the processing of ice-cream products, but it is understood that this can also be equally used for preparing food products different from ice-cream.

The machine essentially comprises a tank 12, equipped with means (not shown) necessary for effecting the heating/cooling of the ingredients being processed in the same. A mixer or rotating stirrer 13 is also assembled inside this basin 12, together with at least one probe 14 suitable for transmitting the corresponding temperature signal to the electronic card with a microprocessor 1 by means of a communication wire 15. The card 1 is in turn connected by a wire 2 to the keyboard 3, the latter suitable for programming the card with the starting commands (temperature of the mixture, processing time, etc.) inserted by the user.

The card 1 is also connected to the inverter 10, driven by the motor 11 which activates the mixer 13, by means of an electronic bidirectional communication circuit 9 with serial transmission and protocol of the Modbus, Canbus or Profibus type, for example. A serial port 4 (for example of the type RS-485) forms part of this electronic circuit 9, equipped with poles 5 and 6 on which the multipolar wires 7 and 8, respectively, in communication with the inverter 10, are inserted. The circuit 9 is therefore of the type suitable for transporting digital signals in packages and with a bidirectional mode (half-duplex or full-duplex). In this transportation, the information is communicated consecutively and sequentially reaches the receiver, in the same order with which it is transmitted by the sender.

A procedure effected in continuous is present on the software charged into the card 1, which sends particular requests to the inverter for knowing its instantaneous state. These commands are in digital format, consisting of packages of data sent at the expiry of a timer (preferably at each Δt=0, 1 s), or with the occurrence of an event, such as for example an alarm, or a pre-established time or temperature. Each package consists of a preamble (ID) which indicates to which inverter it is connected in series (useful in the version of the machine with more than one basin 12a, 12b of FIG. 2), and a control system of the package integrity (called CRC), in addition to the actual process data. The continuous estimation at time “t” of the state of the single inverter (10a, 10b in FIG. 2) serves to understand whether the commands imparted at time “t-1” have been executed or not by the same inverter.

In particular, the card 1 communicates with the inverter 10 through the circuit 9, to identify:
(a) the ID of the inverter;
(b) the state of the inverter (i.e. the operating state of the motor 11), and:
(b1) whether the inverter is operating (mixer in rotation):
   running direction
   running frequency
   measurement of the outlet voltage
   measurement of the power absorbed by the motor
   functioning time
   acceleration time
(b2) whether the inverter is in stop phase (mixer at a standstill):
   running frequency
   measurement of the power absorbed by the motor
   deceleration time
   overall ignition time
(b3) whether the inverter is in alarm state (malfunctioning of the motor):
   running frequency
   last alarm detected.

The responses obtained with this procedure are compared by the card 1 with particular tables present in its memory through the software. At the same time, the other data are also acquired by the probes available (for example the temperature probes 14a, 14b) and these are also compared in the same way.

Each table therefore corresponds to a specific recipe, which has a double function: guiding the processing of the product and controlling the state of each inverter in that particular phase. Said table is composed of lines which represent the processing phases of the particular product and columns which contain the expected values for that phase.

An example of a table for the recipe of pastry cream can be the following, in which:
Arrival T°: is the temperature revealed by the probe 14 at which the phase finishes, if the column “Time” is equal to −1;
Time: if equal to −1 it is not considered; if, on the other hand, it has a value different from −1, it is used as maximum standing time in that phase;
Running direction: FW (forwards)
Hz: rotation rate of the motor 11;
Max Vout: maximum feeding voltage of the motor 11;
Max Iout: maximum feeding current of the motor 11;
Acceleration/deceleration time in the passage of the motor 11 from one velocity regime to another.

| | | | | | | | Accel- |
|---|---|---|---|---|---|---|---|
| | | | | | | | eration/ |
| | | | | | Max | Max | decel- |
| | Arrival | Time | Running | | Vₒᵤₜ | Iₒᵤₜ | eration |
| PHASE | T° | (s) | direction | Hz | [V] | [A] | time (s) |
| Heating | 92 | −1 | FW | 90 | 380 | 10 | 150 |
| Preservation | 92 | 900 | FW | 100 | 380 | 10 | 5 |
| Rapid | 50 | −1 | FW | 75 | 380 | 10 | 100 |
| cooling | | | | | | | |
| Slow cooling | 30 | −1 | FW | 40 | 380 | 12 | 50 |
| Very slow | 4 | −1 | FW | 20 | 380 | 14 | 200 |
| cooling | | | | | | | |
| Preservation | 4 | −1 | FW | 8 | 380 | 14 | 20 |

When it is in the initial “Heating” phase, the card 1 is programmed to command a temperature of 92° C. in the basin 12, with the mixer moving under FW conditions, 90 Hz, 380 V and 10 A, with an acceleration from standstill which has a duration of 150 s. When the temperature at the probe 14 has reached 92° C., the card 1 repeats the previous verification cycle (a), (b) and if the control is successful, the same card activates the subsequent “Preservation” phase. In this phase, the temperature is maintained at 92° C. for a time of 900 seconds and the motor 11 is brought from 90 to 100 Hz in 5 seconds. The card 1 repeats the previous verifications (a) and (b), with the subsequent passage to the remaining phases of the treatment.

In short therefore, the card 1 applies the control procedure described (a) and (b), through which the inverter 10 is continuously monitored up to the subsequent phase, as indicated in the first column in the table. Should a value not in conformance with the expected value for that process reach the microprocessor card, the alarm intervention procedure is applied, which interrogates the inverter with the request to obtain the error which has occurred. The evaluation of the response error is therefore effected by the same procedure which allows the correct safety measurements present in the machine to be applied.

As already mentioned, these tables also refer to the commands to be sent to the inverter 10. The microprocessor card 1 is in fact capable of reading from these tables, the rate and direction for driving the inverter, but also the acceleration or deceleration times for passing from one velocity to another. The transition from 75 Hz of “Rapid cooling” to 40 Hz of “Slow cooling”, for example, could be extremely slow, with a constant reduction in the velocity of numerous tens of seconds. In this way, the complete amalgam of the ingredients recently cooked is ensured, for example for the preparation being examined. The inverter is consequently capable of reproducing the rhythms of the confectioner's hand which knowingly gently slows down the mixing of the paste. For another recipe, on the other hand (for example chocolate tempera) an almost instantaneous acceleration must be established from a low frequency (e.g. 20 Hz) to a high frequency (e.g. 90 Hz), subsequently returning, after a few seconds, again almost instantaneously, to a low frequency, thus generating true velocity peaks.

In the known art, this acceleration/deceleration variation dynamicity from preparation to preparation is impossible to obtain, as a similar variation is always fixed to a value which, if the lid of the basin is opened, is such as to allow the motor to be stopped before the lid is completely open. According to the invention, on the other hand, the alarm procedures, indicating possible danger for the operator, are managed in a recipe program which is separate with respect to the functioning of the inverter, consequently following an independent procedure which commands the inverter to stop the motor very rapidly in the case of a situation of danger for the user (opening of protection doors during the functioning, absorption overcurrents of the motor, intervention of the thermal protections of the same motor).

Consequently, in short, the innovation specifically lies in the possibility of actively controlling the inverter 10 with a safe cross dialogue system with the card 1, in which this communication system is not only used for commanding the functions of the activation inverter and velocity control of the motor 11, but also for interrogating it on its instantaneous state.

Furthermore, the possibility of establishing the acceleration and deceleration rate of the mixer 13 as desired, allows the precision in the processing of products prepared by the machine to be considerably increased, thus obtaining a higher-quality and surprising result. The control of the maximum voltage of the motor, moreover, lengthens the life of the latter, whereas the control of the maximum current absorbed prevents damage of the coils (for example in the case of blockage of the motor due to the formation of ice in the basin 12).

The invention claimed is:

1. A process for processing food products comprising:
providing a food product in at least one basin (12a, 12b);
providing a mixer (13a, 13b) activated by a motor (11a, lib), said mixer mixing the food product in the basin;
providing an inverter (10a, 10b) that controls said motor, the inverter being in communication with an electronic card equipped with a micro-processor (1); and
causing the inverter (10a, 10b) to be in a cross dialogue with said card (1), thereby commanding an interrogation of said inverter (10a, 10b) on an instantaneous state of said inverter.

2. The process according to claim 1, wherein said interrogation of the inverter (10a, 10b) is performed with a continuous procedure, a continuous evaluation at time “t” of the instantaneous state of the inverter (10a, 10b) indicating whether commands imparted at time “t-1” have been executed or not by the inverter.

3. The process according to claim 2, wherein said commands are in digital format and comprise data packages sent with an expiry of a timer or occurrence of a predetermined event.

4. The process according to claim 3, wherein there are a plurality of inverters, and wherein each data package comprises a preamble (ID) which indicates to which inverter (10a, 10b) the data package is directed, and a control system (CRC) of package integrity, in addition to process data.

5. The process according to claim 4, wherein said process data comprise instantaneous temperature of the food product being processed inside said basin (12a, 12b).

6. The process according to claim 4, wherein said process data comprise acceleration/deceleration time of the motor (11a, 11b) during transition regimes from one rotational rate to another rotational rate of the mixer (13a, 13b).

7. The process according to claim 1, wherein said card (1) communicates with the inverter (10a, 10b), in order to know:
(a) ID of the inverter;
(b) the instantaneous state of the inverter; and:
(b1) whether the inverter is operating with the mixer in rotation and the following data:
running direction of the mixer;
running frequency of the mixer,
measurement of outlet voltage;
measurement of power absorbed by the motor;
functioning time of the mixer; and
acceleration time of the mixer;
(b2) whether the inverter is in stop phase with the mixer at a standstill:
running frequency of the mixer;
measurement of the power absorbed by the motor;
deceleration time of the mixer; and
overall ignition time; and
(b3) whether the inverter is in alarm state due to motor malfunctioning:
running frequency of the motor; and
last alarm detected.

8. The process according to claim 7, wherein responses obtained by the method are compared by the card (1) with tables present in a memory of the card through software, wherein each table corresponds to a precise recipe.

9. The process according to claim 8, wherein the table has a double function of guiding product processing and controlling the state of each inverter (10a, 10b) in each step of the processing.

10. The process according to claim 9, wherein said table comprises lines which represent processing steps of a particular product, and columns containing values envisaged for one or more steps of the processing.

11. The process according to claim 10, wherein said table comprises the following parameters:
instantaneous temperature of a blend in the basin (12a, 12b);
running direction of the motor (11a, 11b);
rotational rate of the motor (11a, 11b);
maximum supply voltage of the motor (11a, 11b);
maximum supply current of the motor (11a, 11b);
acceleration/deceleration time in a passage of the motor (11a, 11b) from one speed system to another.

12. A process for processing food products comprising;
providing at least one basin (12a, 12b);
providing a mixer (13a, 13b) activated by a motor (11a, 11b);
providing an inverter (10a, 10b) that controls said motor, said inverter being in communication with an electronic card equipped with a micro-processor (1); and
causing a cross dialogue between said card (1) and the inverter (10a, 10b), thereby commanding functions of the inverter for activation and control of a rate of the motor (11a, 11b).

13. The process according to claim 12, further comprising alarm procedures, to protect an operator from possible danger, said procedures being operated in a card program which is separate with respect to functioning of the inverter.

14. A machine for processing food products comprising:
at least one basin (12a, 12b);
a mixer (13a, 13b) operatively coupled to the basin;
a motor (11a, 11b) actuating the mixer;
an inverter (10a, 10b) controlling the motor, the inverter communicating with a micro-processor electronic card (1); and
means suitable for detecting an instantaneous state of said inverter (10a, 10b).

15. The machine according to claim 13, characterized in that said means comprise an electronic circuit (9) having bidirectional communication and serial transmission.

16. The machine according to claim 15, wherein said electronic circuit (9) is of a serial circuit using Modbus, Canbus, or Profibus protocols.

17. A machine for processing food products comprising;
at least one basin (12a, 12b);
a mixer (13a, 13b) operatively coupled to the basin;
a motor (11a, 11b) actuating the mixer;
an inverter (10a, 10b) controlling the motor, the inverter communicating with a micro-processor electronic card (1); and
an electronic circuit (9) having bidirectional communication and serial protocol, said electronic circuit promoting controlled acceleration/deceleration of said motor (11a, 11b).

18. The machine according to claim 17, wherein said electronic circuit (9) is of a serial circuit using Modbus, Canbus, or Profibus protocols.

19. The machine according to claim 17, further comprising at least one probe (14a, 14b) for measuring temperature of a food product in the basin (12a, 12b).
